(19) United States
(12) Patent Application Publication
(10) Pub. No.: US 2019/0121171 A1
(43) Pub. Date: Apr. 25, 2019

(54) LIQUID CRYSTAL DISPLAY PANEL, LIQUID CRYSTAL DISPLAY DEVICE AND DISPLAY METHOD THEREOF

(71) Applicant: BOE Technology Group Co., Ltd., Beijing (CN)

(72) Inventor: Jifeng Tan, Beijing (CN)

(21) Appl. No.: 15/768,495

(22) PCT Filed: Oct. 24, 2017
(86) PCT No.: PCT/CN2017/107510

§ 371 Date: Apr. 13, 2018

(30) Foreign Application Priority Data
Mar. 2, 2017 (CN) 201710122580.5

(51) Int. Cl. G02F 1/137; G02F 1/1335; G02F 1/13357; G09G 3/36

(52) U.S. Cl. CPC G02F 1/137; G02F 1/133553; G02F 1/1336; G02F 1/134309; G09G 3/3607; G02F 2001/13793; G02F 2001/13775; G02F 1/133504

(57) ABSTRACT

The present disclosure provides a liquid crystal display panel, a liquid crystal display device and a display method thereof in the field of display technology, capable of realizing the gray scale display without taking advantage of the optical rotation characteristic of the liquid crystal layer, such that the thickness of the liquid crystal layer is reduced and the response speed increases. The liquid crystal display panel includes a first base substrate and a light waveguide substrate disposed oppositely, a liquid crystal layer located between the first base substrate and the light waveguide substrate, and a pixel electrode and a common electrode configured to drive the liquid crystal layer. The pixel electrode and the common electrode are configured to drive the refractive index of the liquid crystal layer to be changed. The light output rate of the light waveguide substrate changes according to the change of the refractive index of the liquid crystal layer.

This application claims priority to Chinese Patent Application No. 201710122580.5, filed with the State Intellectual Property Office on Mar. 2, 2017 and titled “LIQUID CRYSTAL DISPLAY PANEL, DISPLAY DEVICE AND DISPLAY METHOD THEREOF,” the entire contents of which are incorporated herein by reference.

### TECHNICAL FIELD

The present disclosure relates to display technology, and more particularly to a liquid crystal display panel, a liquid crystal display device and a display method thereof.

### BACKGROUND

In the current display market, liquid crystal display (LCD) devices have the characteristics of small size, low power consumption, no radiation and relatively low manufacturing cost, etc., and are thus more and more widely applied to the field of high-performance display.

For the current LCD, by disposing an upper polarizer and a lower polarizer on two sides of a liquid crystal layer, under the drive of electrodes, polarized light transmitted through the lower polarizer is distorted and rotates in the liquid crystal layer for the optical rotation characteristics of the liquid crystal molecules, and therefore the polarization direction of the polarized light changes. Thus, the quantity of output light transmitted through the upper polarizer is adjusted to realize the display of different gray scales.

However, if the gray scale display is realized by the optical rotation characteristic of the liquid crystal layer, it should be ensured that the liquid crystal layer has a certain thickness, which is generally 3-5 μm. Since the thickness of the liquid crystal layer is large, the response speed of the LCD is slow, which is unfavorable for display.

### SUMMARY

The present disclosure provides a liquid crystal display panel, a liquid crystal display device and a display method thereof, capable of realizing the gray scale display without taking advantage of the optical rotation characteristic of the liquid crystal layer, such that the thickness of the liquid crystal layer is reduced and the response speed increases. The technical solutions adopted in the embodiments of the present disclosure may be as follows.

In a first aspect of the present disclosure, there is provided a liquid crystal display panel, comprising: a first base substrate and a light waveguide substrate disposed oppositely; a liquid crystal layer located between the first base substrate and the light waveguide substrate, and a pixel electrode and a common electrode which are located between the first base substrate and the light waveguide substrate and are configured to drive the liquid crystal layer; wherein the pixel electrode and the common electrode are configured to drive a refractive index of the liquid crystal layer to be changed, and thereby a light output rate of the light waveguide substrate is changed according to a change of the refractive index of the liquid crystal layer.

Further, the liquid crystal display panel further comprises a reflective layer located between the liquid crystal layer and the first base substrate. The reflective layer is configured to reflect light rays transmitted through the liquid crystal layer and incident to the reflective layer.

Further, a minimal reflective index of the liquid crystal layer is the refractive index of the liquid crystal layer when the liquid crystal layer is not driven by the pixel electrode and the common electrode, and when the refractive index of the liquid crystal layer is the minimal refractive index, incident light rays incident to the light waveguide substrate from a side surface of the light waveguide substrate are totally reflected in the light waveguide substrate.

Further, the light waveguide substrate is an integral substrate; or the light waveguide substrate comprises a second base substrate and a waveguide layer disposed on the second base substrate, and the waveguide layer is adjacent to the liquid crystal layer relative to the second base substrate.

Further, the light waveguide substrate is a transparent light guide glass plate made of silicon nitride.

Further, the liquid crystal display panel further comprises: a color filter layer located on one side of the liquid crystal layer away from the first base substrate. The liquid crystal display panel is divided into a plurality of primary color sub-pixels, and the color filter layer comprises a first primary color pattern located in first primary color sub-pixels, a second primary color pattern located in second primary color sub-pixels and a third primary color pattern located in third primary color sub-pixels.

Further, the reflective layer is a reflective grating, and the reflective grating comprises grating units in an array arrangement. The grating units comprise first grating sub-units configured to emit first primary color light rays, second grating sub-units configured to emit second primary color light rays and third grating sub-units configured to emit third primary color light rays.

Further, the first grating sub-units are configured to emit the first primary color light rays towards a viewing position, the second grating sub-units are configured to emit the second primary color light rays towards the viewing position, and the third grating sub-units are configured to emit the third primary color light rays towards the viewing position.

Further, the reflective grating is a blazed grating or columnar grating.

Further, a duty ratio of the reflective grating is 0.5, the value range of a height of the reflective grating is 200 nm-1000 nm, and the value range of a period of the reflective grating is 100 nm-1 μm.

Further, the liquid crystal layer is in contact with the light waveguide substrate.

Further, the light output rate of the light waveguide substrate is in a positive correlation with the refractive index of the liquid crystal layer.

Further, liquid crystal molecules in the liquid crystal layer are nematic phase liquid crystal molecules, blue phase liquid crystal molecules or polymer-stabilized liquid crystal molecules.

Further, the liquid crystal molecules in the liquid crystal layer are nematic phase liquid crystal molecules, and the liquid crystal display panel further comprises an alignment layer located on each side of the liquid crystal layer and is in contact with the liquid crystal layer.

Further, the pixel electrode and the common electrode are located on the same side of the liquid crystal layer, and the liquid crystal display panel further comprises a polarizer located on a light incident side or light emergent side of the liquid crystal layer.

In a second aspect of the present disclosure, there is provided a liquid crystal display device, comprising a light source and the liquid crystal display panel in the first aspect. The light source is located on a side surface of a light waveguide substrate of the liquid crystal display panel.

Further, the light waveguide substrate comprises a second base substrate and a waveguide layer disposed on the second base substrate, and the light source is located on a side surface of the second base substrate and/or the waveguide layer.

Further, the light source adopts a collimation light source made of a semiconductor laser chip, a collimation light source made of a light emitting diode or a collimation light source made of a cold cathode fluorescence lamp.

In a third aspect of the present disclosure, there is provided a display method applied to the above-mentioned liquid crystal display device. The method includes: scanning sub-pixels in the liquid crystal display device row by row; and when a row of sub-pixels are scanned, applying an electrical field to a liquid crystal layer of the row of sub-pixels according to a gray scale value of each primary color sub-pixel, to change a refractive index of the liquid crystal layer of each primary color sub-pixel.

The present disclosure provides a liquid crystal display panel, a liquid crystal display device and a display method thereof. In the liquid crystal display panel, the liquid crystal layer located between the first base substrate and the light waveguide substrate disposed oppositely is driven by the pixel electrode and the common electrode, such that the refractive index of the liquid crystal layer is changed, and thereby the light output rate of the light waveguide substrate is adjusted. In this way, the gray scale display can be realized without adopting the optical rotation characteristic of the liquid crystal layer. The refractive index of the liquid crystal layer is changed by adjusting the electric signal applied to the pixel electrode and the common electrode, and thereby the light output rate of the light waveguide substrate is adjusted. That is, the display of different gray scales may be realized by a thinner liquid crystal layer. Thus, the liquid crystal display panel has a faster response speed.

### BRIEF DESCRIPTION OF THE DRAWINGS

To describe the technical solutions in the embodiments of the present disclosure or in the related art more clearly, the following briefly introduces the accompanying drawings required for describing the embodiments or the related art. Apparently, the accompanying drawings in the following description show merely some embodiments of the present disclosure, and a person of ordinary skill in the art may still derive other drawings from these accompanying drawings without creative efforts.

FIG. 1 is a structural diagram of a liquid crystal display device provided in the related art;

FIG. 2a is a structural diagram of a liquid crystal display device provided in an embodiment of the present disclosure;

FIG. 2b is a structural diagram of another liquid crystal display device provided in an embodiment of the present disclosure;

FIG. 3 is a schematic diagram of light transmission principle for a waveguide layer provided in an embodiment of the present disclosure;

FIG. 4 is a structural diagram of another liquid crystal display device provided in an embodiment of the present disclosure;

FIG. 5 is a structural diagram of yet another liquid crystal display device provided in an embodiment of the present disclosure;

FIG. 6 is a structural diagram of yet another liquid crystal display device provided in an embodiment of the present disclosure;

FIG. 7a is a schematic diagram of a diffraction light path of a columnar grating provided in an embodiment of the present disclosure;

FIG. 7b is a schematic diagram of a diffraction light path of a blazed grating provided in an embodiment of the present disclosure;

FIG. 8 is a structural schematic diagram of yet another liquid crystal display device provided in an embodiment of the present disclosure; and

FIG. 9 is a flow chart of a method for displaying a liquid crystal display device provided in an embodiment of the present disclosure.

### DETAILED DESCRIPTION

The technique solutions in embodiments of the present disclosure will be described in a clear and comprehensive manner with reference to the enclosed drawings. The embodiments described are not representative of all embodiments consistent with the present disclosure. Rather, they are merely some embodiments of the present disclosure. Based on the embodiments of the present disclosure, all other embodiments derived by a person of ordinary skill in the art without creative efforts shall fall into the scope of protection of the present disclosure.

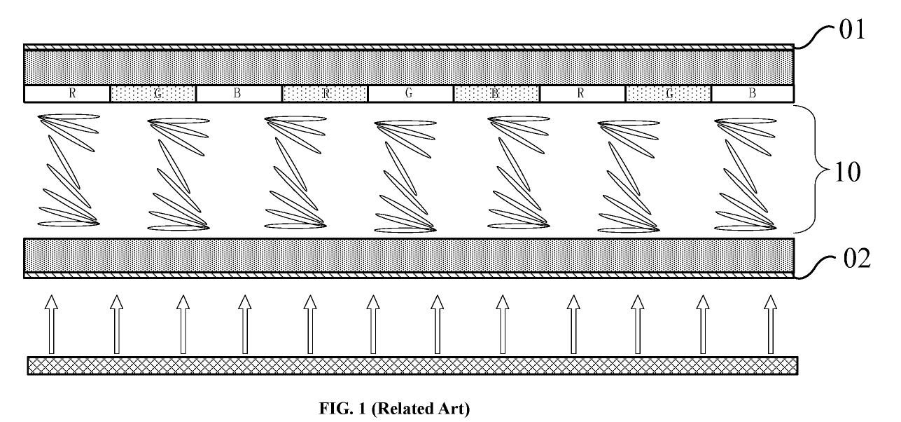

FIG. 1 is a structural schematic diagram of a current common LCD. As shown in FIG. 1, an upper polarizer 01 and a lower polarizer 02 are disposed on each side of a liquid crystal layer 10. Under the drive of an electrode, polarized light transmitted through the lower polarizer 02 is distorted and rotates in the liquid crystal layer 10 for the optical rotation characteristic of the liquid crystal molecules, and thereby the polarization direction of the polarized light is changed. Therefore, the quantity of output light transmitted through the upper polarizer 01 may be adjusted to realize the display of different gray scales. However, if the gray scale display is realized by the optical rotation characteristic of the liquid crystal layer 10, it should be ensured that the liquid crystal layer 10 has a certain thickness. Since the thickness of the liquid crystal layer 10 is large, the response speed of the LCD is slow, which is unfavorable for display.

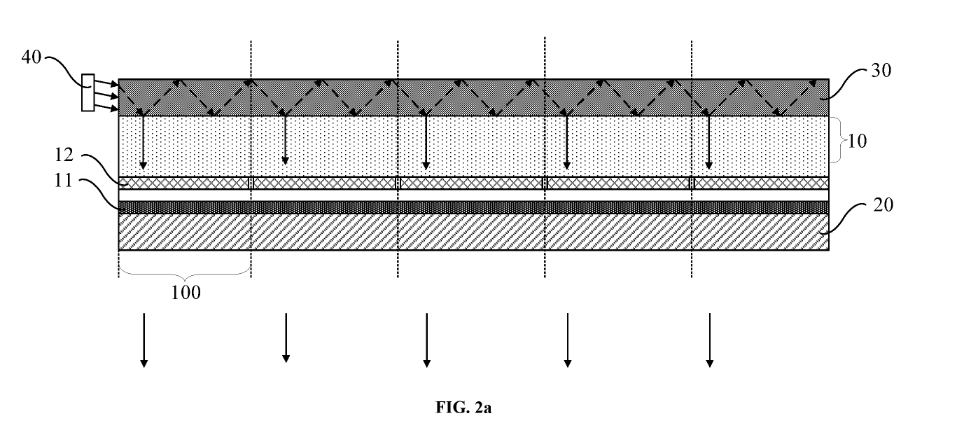

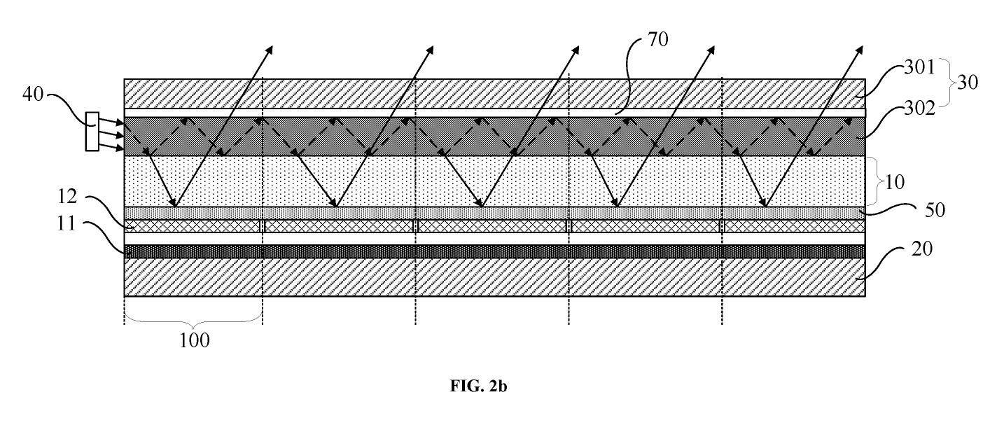

FIG. 2a shows a structural schematic diagram of a liquid crystal display device provided by an embodiment of the present disclosure. The liquid crystal display device comprises a liquid crystal display panel in the embodiments of the present disclosure. The liquid crystal display panel comprises a first base substrate 20 and a light waveguide substrate 30 disposed oppositely. Of course, when the liquid crystal display panel is applied to a liquid crystal display device, as shown in FIG. 2a, the liquid crystal display device comprises a light source 40 located on a side surface of the light waveguide substrate 30. Light rays emitted by the light source 40 may be transmitted in the light waveguide substrate 30. Since the light source 40 is disposed on a side surface of the light waveguide substrate 30, the light source 40 is also called as a side-lit light source.

As shown in FIG. 2a, the liquid crystal display panel further comprises a liquid crystal layer 10 located between the first base substrate 20 and the light waveguide substrate 30, and a common electrode 11 and a pixel electrode 12 which are located between the first base substrate 20 and the light waveguide substrate 30 and are configured to drive the liquid crystal layer 10. The common pixel 11 and the pixel electrode 12 are configured to drive the refractive index of the liquid crystal layer 10 to be changed by applying an electrical field to the liquid crystal layer 10. The light output rate of the light waveguide substrate 30 is changed according to the change of the refractive index of the liquid crystal layer 10. That is, under the drive of the common electrode 11 and the pixel electrode 12, the refractive index of the liquid crystal layer 10 may be changed, and thereby the light output rate of the light waveguide substrate 30 is changed. Therefore, the light output rate of the light waveguide substrate 30 may be adjusted by controlling the refractive index of the liquid crystal layer 10 through the pixel electrode 12 and the common electrode 11.

It should be noted that as shown in FIG. 2a, the common electrode 11 and the pixel electrode 12 may be disposed between the first base substrate 20 and the light waveguide substrate 30. When the light source 40 is disposed on the side surface of the light waveguide substrate 30, it is better that the light rays emitted by the light source 40 may be transmitted towards the light waveguide substrate 30 as much as possible, and are not incident to the liquid crystal layer 10 and layers above the liquid crystal layer 10. It should be further noted that in the embodiment of the present disclosure, as shown in FIG. 2a, the liquid crystal display panel is divided into a plurality of primary color sub-pixels 100. Each of the plurality of primary color sub-pixels 100 has a corresponding pixel region on the liquid crystal display panel. The pixel region comprises a region of the light waveguide substrate 30 belonging to the primary color sub-pixel 100, a region of the liquid crystal layer 10 belonging to the primary color sub-pixel 100, a region of the common electrode 11 belonging to the primary color sub-pixel 100 and a region of the pixel electrode 12 belonging to the primary color sub-pixel 100.

Here, the following should be noted.

Firstly, the light output rate of the above light waveguide substrate 30 refers to the output efficiency when the light rays transmitted in the light waveguide substrate 30 are output from the light waveguide substrate 30. When the output efficiency is high, the light output quantity of the light waveguide substrate 30 is large. When the output efficiency is low, the light output quantity of the light waveguide substrate 30 is small.

Secondly, in some embodiments, as shown in FIG. 2a, the liquid crystal layer 10 may be in direct contact with the light waveguide substrate 30, so that the accuracy of adjusting the light output rate of the light waveguide substrate 30 by adjusting the refractive index of the liquid crystal layer 10 may be ensured. An adverse effect on the light output of the light waveguide substrate 30 caused by disposing other film layers between the liquid crystal layer 10 and the light waveguide substrate 30 is avoided. Of course, under the condition that the film layers disposed between the liquid crystal layer 10 and the light waveguide substrate 30 are thin enough, the effect on the light output of the light waveguide substrate 30 caused by such film layers may be negligible. Therefore, the film layers thin enough may be disposed between the liquid crystal layer 10 and the light waveguide substrate 30.

In conclusion, according to the liquid crystal display panel provided by the embodiment of the present disclosure, an electric signal applied to the pixel electrode and the common electrode is adjusted to drive the refractive index of the liquid crystal layer to be changed to further adjust the light output rate of the light rays transmitted in the light waveguide substrate. In this way, the gray scale display may be realized without adopting the optical rotation characteristic of the liquid crystal layer. The refractive index of the liquid crystal layer is changed by adjusting the electric signal applied to the pixel electrode and the common electrode, and further the light output rate of the light waveguide substrate is adjusted. That is, the display of different gray scales is realized by the thinner liquid crystal layer, thereby causing the liquid crystal display panel to have a faster response speed.

In addition, FIG. 2b shows a structural schematic diagram of another liquid crystal display device provided by an embodiment of the present disclosure. Based on FIG. 2a, the liquid crystal display panel further comprises a reflective layer 50 located between the liquid crystal layer 10 and the first base substrate 20. The reflective layer 50 is configured to reflect light rays transmitted through the liquid crystal layer 10 and incident to the reflective layer 50. That is, the light rays output from the light waveguide substrate 30 enter the liquid crystal layer 10 and reach the reflective layer 50 after being transmitted through the liquid crystal layer 10, and may be emitted from the liquid crystal display panel after being reflected by the reflective layer 50. As shown in FIG. 2b, the light rays reflected by the reflective layer 50 pass through the liquid crystal layer 10 and the light waveguide substrate 30 and are emitted from the light waveguide substrate 30. It should be noted that in practice, the light rays reaching the reflective layer 50 may be reflected on the reflective layer 50 and are emitted from the light waveguide substrate 30. The liquid crystal display panel having the reflective layer 50 is taken as an example in the following embodiments to further explain the embodiments of the present disclosure.

The input and output of the light rays by the light waveguide substrate 30 are further explained below.

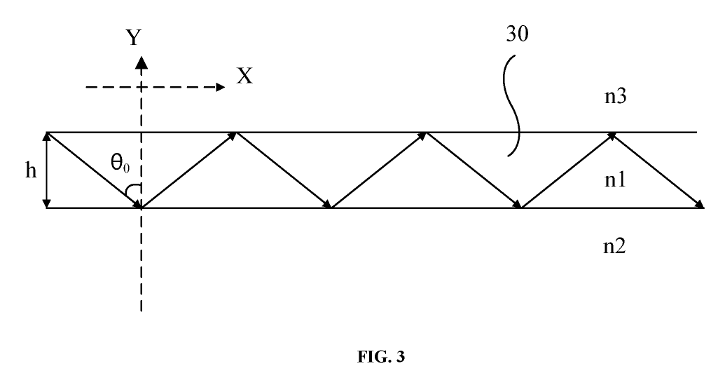

As shown in FIG. 3, it is shown by taking an example in which the refractive index of a waveguide layer is n1, the refractive index of a second medium layer on the lower side of the light waveguide substrate 30 is n2, and the refractive index of a third medium layer on the upper side of the light waveguide substrate 30 is n3. The refractive index n1 of the waveguide layer is larger than the refractive indexes n2 and n3 of the medium layers on the two sides. The difference between the refractive index n1 of the waveguide layer and the refractive indexes n2 and n3 of the medium layers on the two sides is 0.1-0.001. That is, the difference between n1 and n2 is 0.1-0.001 and the difference between n1 and n3 is 0.1-0.001.

In some embodiments, by taking n1≥n2≥n3 as an example, when the incident angle θ of the incident light rays incident to the second medium layer from the waveguide layer is larger than 80 (sin θ0=n2/n1), the incident light rays are limited to be transmitted in the waveguide layer. That is, the incident light rays are totally reflected in the contact interfaces between the waveguide layer and the mediums on both sides of the waveguide layer. Here, the incident light rays incident to the waveguide layer are transmitted along a Z-shaped path in the waveguide layer. The light rays in the waveguide layer are restrained in the Y direction but not restrained in the X direction.

In addition, in on order to ensure stable transmission of the incident light rays in the waveguide layer, the following condition needs to be further met:

2kh−2φ₁₂−2φ₁₃=2mπ, m=0,1, 2, 3

Wherein, k=k₀n1 cos θ. k0 is a wave number in vacuum. m is a mode order, i.e., a positive integer from 1. φ₁₂ is a total reflective phase difference between the waveguide layer and the second medium layer. φ₁₃ is a total reflective phase difference between the waveguide layer and the third medium layer.

In the embodiment of the present disclosure, by adjusting the refractive index n2 of the second medium layer, a part of the incident light rays may be incident into the second medium layer when the incident light rays emitted to the second medium layer from the waveguide layer are reflected on the contact interface between the waveguide layer and the second medium layer. Of course, by controlling the difference value between the refractive index n2 of the second medium layer and the refractive index n1 of the waveguide layer, the light output rate of the light rays emitted from the waveguide layer may be controlled. For example, when the incident light rays emitted to the second medium layer from the waveguide layer at the incident angle θ are totally reflected in the second medium layer, sin θ=n2/n1. On such a basis, if the refractive index n2 of the second medium layer is increased, and sin θ<n2/n1, then the light rays in the waveguide layer may be incident to the second medium layer at a first light output rate. Further, if the refractive index n2 of the second medium layer is further increased, the light rays in the waveguide layer may be incident to the second medium layer at a second light output rate. The second light output rate is higher than the first light output rate.

Of course, for the liquid crystal display panel in the embodiment of the present disclosure, the light waveguide substrate 30 is the waveguide layer. The second medium layer that is on one side of the light waveguide substrate 30 and whose refractive index is adjustable may be the liquid crystal layer 10. The third medium layer located on the other side of the light waveguide substrate 30 may be air, or other film layers. The specific arrangement is set according to actual product needs, and is not limited in the embodiment of the present disclosure. In the embodiment of the present disclosure, when the second medium layer is the liquid crystal layer 10, if the refractive index n2 of the second medium layer is increased, the light rays in the waveguide layer may be incident to the second medium layer at the first light output rate. If the refractive index n2 of the second medium layer is further increased, the light rays in the waveguide layer are incident to the second medium layer at the second light output rate, and the second light output rate is higher than the first light output rate. Therefore, when the refractive index of the liquid crystal layer 10 increases, the light output rate of the light rays in the waveguide layer also increases. Hence, according to the liquid crystal display panel provided by the embodiment of the present disclosure, the light output rate of the light waveguide substrate 30 (i.e., the waveguide layer) is in a positive correlation with the refractive index of the liquid crystal layer 10.

Based on the adjustable refractive index of the above liquid crystal layer 10, when the refractive index of the liquid crystal layer 10 changes between a minimal refractive index and a maximal refractive index under the drive of the common electrode 11 and the pixel electrode 12, in order to ensure that the liquid crystal display panel may realize total gray scale display (L0-L255), in some embodiments, the light rays incident to the light waveguide substrate 30 may be set to be totally reflected on the contact interfaces between the light waveguide substrate 30 and the medium layers on both sides of the light waveguide substrate 30 when the refractive index of the liquid crystal layer 10 is the minimal refractive index. That is, no light rays are coupled from the light waveguide substrate 30, and the liquid crystal display panel can realize L0 gray scale display. When the refractive index of the liquid crystal layer 10 is the maximal refractive index, the light output rate of the light waveguide substrate 30 is maximal, and the liquid crystal display panel can realize L255 gray scale display. Of course, in order to reduce the energy consumption of the liquid crystal display panel while the total gray scale display is realized, the minimal refractive index of the liquid crystal layer 10 may be set to be the refractive index when the liquid crystal layer 10 is not driven by the common electrode 11 and the pixel electrode 12, and such a refractive index may be called as the initial refractive index of the liquid crystal layer 10. In the embodiment of the present disclosure, when the refractive index of the liquid crystal layer 10 is the minimal refractive index, the incident light rays incident to the light waveguide substrate 30 from the side surface of the light waveguide substrate 30 are totally reflected in the light waveguide substrate 30.

In addition, as shown in FIG. 2b, the above light waveguide substrate 30 may comprise a second base substrate 301 and a waveguide layer 302 disposed on the second base substrate 301. The waveguide layer 302 is adjacent to the liquid crystal layer 10 relative to the second base substrate 301. In such a case, the light source 40 may be located on the side surface of the second base substrate 30 and/or the waveguide layer 302. Of course, in practice, the light waveguide substrate 30 may be an integral substrate shown in FIG. 2a. That is, the second base substrate 301 and the waveguide layer 302 in FIG. 2b are of the same interlayer structure. For example, the light waveguide substrate 30 may be a transparent light-guide glass plate. Of course, in order to ensure the normal transmission of the light rays by the light waveguide substrate 30, the light waveguide substrate 30 may be made of a material with a higher refractive index, for example, Si3N4, which is not limited in the embodiment of the present disclosure. The following embodiment takes the light waveguide substrate 30 comprising the second base substrate 301 and the waveguide layer 302 as an example for further explanation.

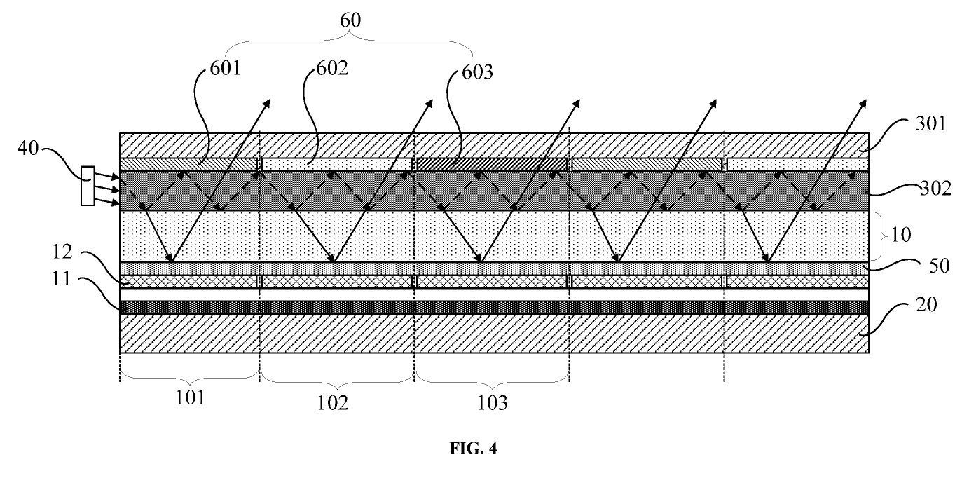

In the embodiment of the present disclosure, based on FIG. 2b, in order to realize color display, a color filter layer may be disposed in the liquid crystal display panel to filter the light rays. As shown in FIG. 4, the liquid crystal display panel further comprises a color filter layer 60 located on one side of the liquid crystal layer 10 away from the first base substrate 20. For example, as shown in FIG. 4, the color filter layer 60 may be disposed between the second base substrate 301 and the waveguide layer 302. Of course, in practice, the color filter layer 60 may also be disposed in other interlayer positions, which is not limited in the embodiment of the present disclosure. In combination with FIGS. 2b and 4, the plurality of primary color sub-pixels 100 of the liquid crystal display panel may comprise first primary color sub-pixels 101, second primary color sub-pixels 102 and third primary color sub-pixels 103. The color filter layer 60 may comprise a first primary color pattern 601 located in the first primary color sub-pixels 101, a second primary color pattern 602 located in the second primary color sub-pixels 102, and a third primary color pattern 603 located in the third primary color sub-pixels 103.

The first primary color pattern 601 is configured to filter white light rays to allow the first primary color light rays in the white light rays to transmit through the color filter layer 60. The second primary color pattern 602 is configured to filter the white light rays to allow the second primary color light rays in the white light rays to transmit through the color filter layer 60. The third primary color pattern 603 is configured to filter the white light rays to allow the third primary color light rays in the white light rays to transmit through the color filter layer 60. In practice, the first to third primary colors may be red color, green color and blue color respectively. The plurality of primary color sub-pixels 100 may further comprise fourth primary color sub-pixels (not shown in FIG. 4), fifth primary color sub-pixels (not shown in FIG. 4), etc. Correspondingly, the color filter layer 60 may comprise a fourth primary color pattern (not shown in FIG. 4) located in the fourth primary color sub-pixels, and a fifth primary color pattern (not shown in FIG. 4), etc.

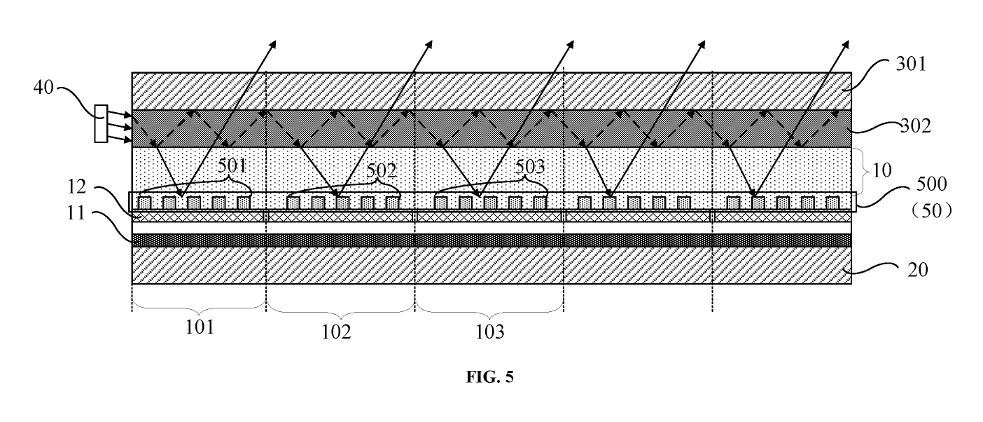

Of course, in the embodiment of the present disclosure, based on FIG. 2b, in order to realize color display, the light rays may be applied with light splitting using the light splitting performance of a grating. Then as shown in FIG. 5, the reflective layer 50 may be set to be a reflective grating 500, and the reflective grating 500 comprises grating units in an array arrangement. The grating units in an array arrangement comprise first grating sub-units 501 configured to emit first primary color light rays, second grating sub-units 502 configured to emit second primary color light rays and third grating sub-units 503 configured to emit third primary color light rays.

In the arrangement mode of the above reflective grating 500, the color display may be realized without disposing the color filter layer. In such a case, the layers of the liquid crystal display panel may be made of a transparent material, so that the liquid crystal display panel has a relatively high transmittance, which is favorable to the application in the field of transparent display.

Here, the following should be noted.

Firstly, for the case where different primary color light rays are emitted from different grating sub-units using the light splitting performance of the above reflective grating 500, the light rays incident from the side surface of the light waveguide substrate 30 may be set to be collimation light rays. That is, the light source 40 in FIG. 5 may be a collimation light source. In some embodiments, the collimation light source may be made from a semiconductor laser chip of red, green and blue colors, or a light emitting diode (LED) chip of red, green and blue colors through collimation and beam expansion, or a while light LED chip through collimation and beam expansion, or a strip-shaped cold cathode fluorescent lamp (CCFL) along with some light ray collimation structures, which is not limited in the embodiment of the present disclosure.

Secondly, the material for making the above reflective grating 500 may be selected from, for example at least one of metal Al or Ag with a high reflectivity. The duty ratio of the reflective grating 500 may be 0.5. When the duty ratio of the reflective grating is 0.5, the diffraction rate of the reflective grating 500 to light is the maximal diffraction rate. However, in actual product design, the duty ratio of the reflective grating 500 may also deviate from this value. For example, the duty ratio of the reflective grating 500 may be set according to the factors such as light emergent intensity, the balance on the brightness difference in different positions of the liquid crystal display panel, and technological conditions, etc., which is not limited in the embodiment of the present disclosure. In addition, the heights of the grating bars in the reflective grating 500 may be generally set between 200 nm-1000 nm, such as 300 nm or 500 nm. That is, the value range of the height of the reflective grating 500 may be 200 nm-1000 nm, such as 300 nm or 500 nm. Of course, the heights of the grating bars corresponding to all sub-pixels may be set to be the same height according to actual needs, or the heights of the grating bars corresponding to different sub-pixels may be set to be different heights, which is not limited in the embodiment of the present disclosure.

Thirdly, as the requirements on display definition becomes higher, the demand for high pixels per inch (PPI) display devices also increases. However, limited by the manufacturing process, the high PPI display devices are hard to develop. In the embodiment of the present disclosure, the period of the above reflective grating 500 may be set to be smaller. For example, the value range of the period of the reflective grating 500 is set to be about 100 nm-1 μm. In this way, the sizes of the sub-pixels corresponding to the first grating sub-units 501, the second grating sub-units 502 and the third grating sub-units 503 are smaller which is favorable to realize the high definition of the liquid crystal display panel.

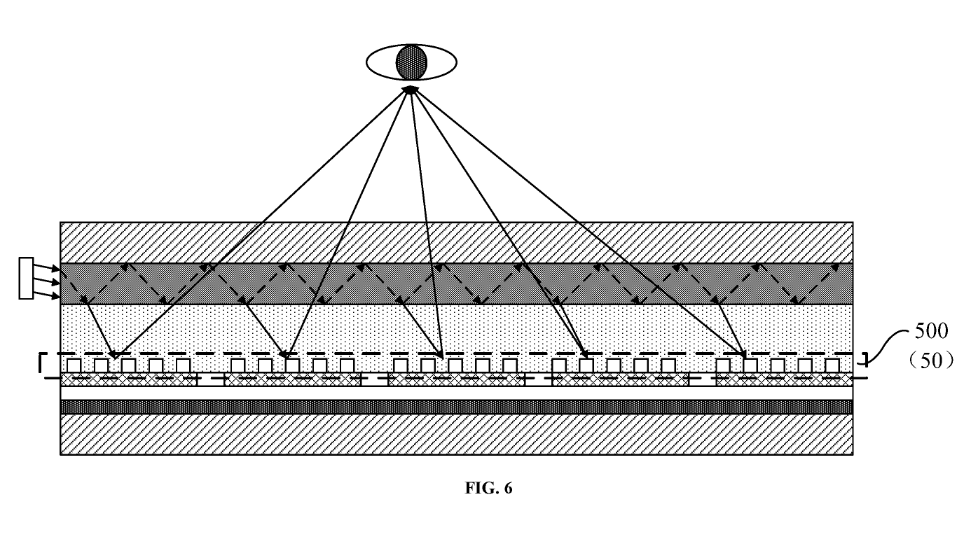

Further, based on FIG. 5, as shown in FIG. 6, by disposing the periods of the first grating sub-units 501, the second grating sub-units 502 and the third grating sub-units 503, the first grating sub-units 501 are enabled to emit the first primary color light rays towards a viewing position, the second grating sub-units 502 are enabled to emit the second primary color light rays towards a viewing position, and the third grating sub-units 503 are enabled to emit the third primary color light rays towards a viewing position. That is, the emergence of the given primary color light rays in a given direction may be realized, such that the liquid crystal display panel may be applied to the fields of near-to-eye display, augmented reality (AR) display and virtual reality (VR) display.

The principle that the above reflective grating 500 realizes the emergence of the given primary color light rays in the given direction is further explained. Of course, the reflective grating 500 may be a columnar grating, or a blazed grating.

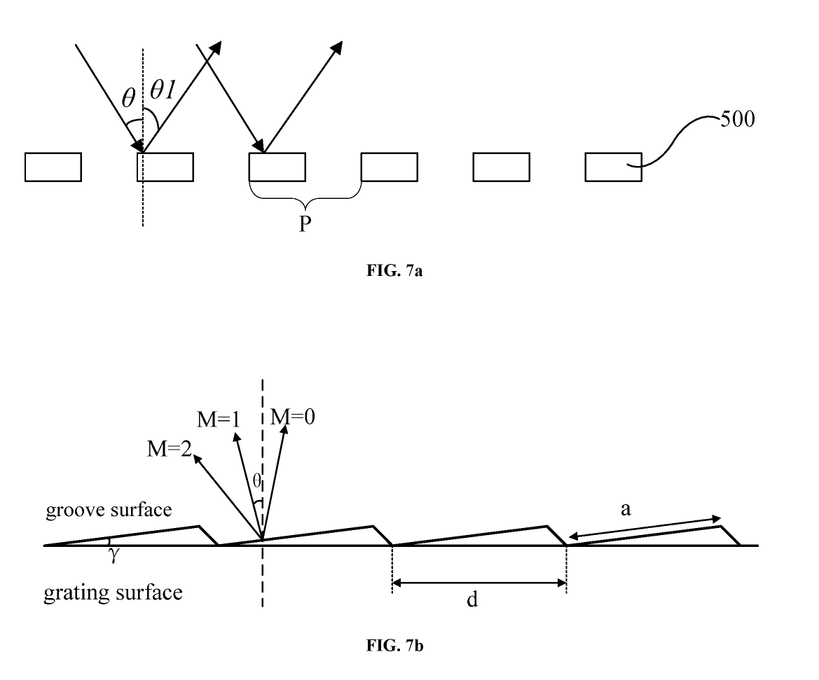

For example, when the reflective grating 500 is a columnar grating, as shown in FIG. 7a, for m-th order diffraction light, according to a reflective grating diffraction equation, an incident angle θ, a diffraction angle θ1, a grating period P and a light ray wavelength λ of the light rays incident to the reflective grating 500 meet the following grating equation:

sin θ+sin θ1=mλ/P, m=1,2,3

From the grating equation, it can be seen that in a case of the given incident angle θ, the light rays of the given wavelength λ may be emitted at the given diffraction angle θ1 by setting the grating period P.

Of course, for the columnar grating, the diffraction intensity of 0 order diffraction and 1 order diffraction is larger. The diffraction intensity of high orders is much smaller than the former two. The diffraction direction of a 0 order spectrum is in a corresponding reflective light direction. The diffraction direction of a 1 order spectrum may be adjusted and controlled by the period of the columnar grating. Therefore, 1 order diffracted waves are generally used for the adjustment of the angles of the light rays. After the light emergent direction is given, the grating periods corresponding to the color light of different wavelengths meet the foregoing grating equation.

Of course, the heights of the grating bars of the columnar grating may also be set according to actual needs. For example, for the purpose of eliminating, weakening or intensifying the zero order diffracted waves of certain color light, the heights of the grating bars may be designed according to the wavelength of such color light. Since the incident angle is generally constant, when the phase difference of the color light between the grating bar and the gap of the columnar grating is odd number times of a half wavelength, the zero order diffracted waves are applied with coherence and cancellation, the zero order diffracted waves are coherent and weakened, and first order diffracted waves are enhanced. When the phase difference of the color light between the grating bar and the gap of the columnar grating is integer times of the wavelength, the zero order diffracted waves are coherent and intensified, and the first order diffracted waves are weakened. For different color light, different grating heights or the same grating height may be selected, which is not limited in the embodiment of the present disclosure.

From above, it can be known that the gratings of different periods may be provided in different pixel regions, such that light rays of different colors may be seen at specific angles, and the application of the liquid crystal display panel to the field such as near-to-eye display or AR may be met. Of course, a scattering film may be disposed on the outermost layer of the device structure (for example, the scattering film is disposed on one side of the light waveguide substrate 30 away from the liquid crystal layer 10) to realize normal display. Alternatively, in order to realize the color saturation of a display picture color filter layer may be disposed on the light waveguide substrate 30.

For another example, when the reflective grating 500 is a blazed grating, as shown in FIG. 7b, it can be known from the diffraction theory that when the light rays are incident along the normal direction of a groove surface, the incident angle θ of the light rays incident to the reflective grating 500 is the same as a m order diffraction angle, and then the incident angle θ, a grooving period d of the reflective grating 500, and the light ray wavelength λ meet the following main blazed condition:

2d sin θ=mλ

Wherein d is the grooving period, θ is the incident angle, and the diffraction angle equals to the incident angle θ and the blazed angle γ, that is, θ=γ. Then, the diffractive central maximum of a single groove surface coincides with the m order primary maximum interfered among the groove surfaces. That is, the coincidence condition of an m order spectrum is 2 d sin γ=mλ. For example, for the 1 order spectrum, 2 d sin γ=λ. Since the groove surface width a of the blazed grating is approximately equal to the growing period d, the light of other orders coincides with the diffractive minimum of the single groove surface, resulting in the low spectral intensity of these diffraction.

In conclusion, by setting the grooving period of the blazed grating, the light rays of different colors may be seen at specific angles, thereby achieving the application of the liquid crystal display panel in the fields such as near-to-eye display or AR, etc. Of course, the blazed grating may transfer most incident energy to the desired m order spectrum according to needs, the ratio of the spectrums of other orders to the total energy is very low, and the technical effect of blazing the spectrum of a certain order is achieved. Therefore, the reflective grating 500 in the embodiment of the present disclosure may adopt the blazed grating.

In addition, the liquid crystal display device comprising the above liquid crystal display panel may be a vertical field display device, or a planar field display device. Wherein, the vertical field display device comprises for example, an electrically controlled birefringence (ECB) type display device, a vertical alignment (VA)-like display device or a twisted nematic (TN)-like display device, etc. The planar field display device comprises for example, an advanced-super dimensional switching (ADS) type display device or an in plane switch (IPS) type display device, etc.

It should be noted that for the above different types of liquid crystal display devices, the liquid crystal in the liquid crystal layer 10 in the embodiments of the present disclosure may be a nematic phase liquid crystal or blue phase liquid crystal, and of course, may also be other polymer-stabilized liquid crystal. Therefore, liquid crystal molecules in the liquid crystal layer 10 may be nematic phase liquid crystal molecules, blue phase liquid crystal molecules or polymer-stabilized liquid crystal molecules. In the case that the liquid crystal molecules are the nematic phase liquid crystal molecules, in order to ensure that the liquid crystal molecules are in the same arrangement state initially and may be deflected according to an expected mode after being applied with an electrical field, the liquid crystal display panel in the embodiment of the present disclosure further comprises an alignment layer located on each side of the liquid crystal layer and is in contact with the liquid crystal layer. The alignment layer can orient the nematic phase liquid crystal molecules, such that the nematic phase liquid crystal molecules have the same initial state under the action of the alignment layer. In the case that the liquid crystal molecules are the blue phase liquid crystal molecules, no alignment layer is required to be disposed. Generally, the alignment layer may be a polyimide (PI) film. In practice, the alignment direction of the alignment layer may be selected according to a normal black/normal white mode, which is not limited in the embodiment of the present disclosure.

In addition, when the liquid crystal display panel is applied to the planar field display device, and the liquid crystal molecules in the liquid crystal display panel are nematic phase liquid crystal molecules, a polarizer may be disposed on a light incident side or light emergent side of the liquid crystal layer 10 to polarize the light rays. When the liquid crystal display panel is applied to the vertical field display device, and the liquid crystal molecules in the liquid crystal display panel are nematic phase liquid crystal molecules, no polarizer is required to be disposed.

The process of adjustment on different gray scales by the vertical field display device and the planar field display device in different implementing manners is further explained below.

Implementing Manner I

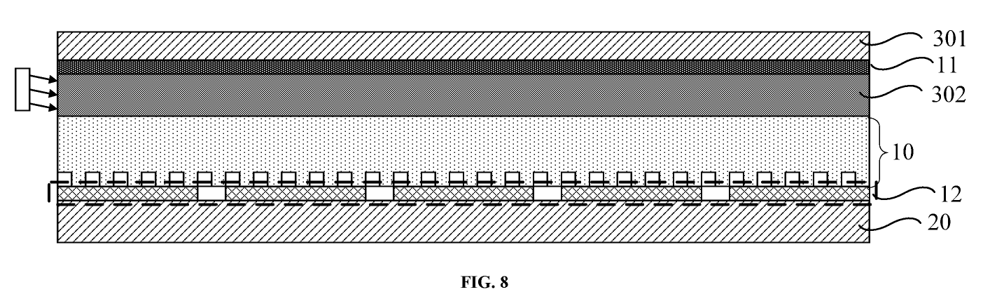

As shown in FIG. 8, the liquid crystal display panel in embodiment of the present disclosure being applied to the VA-like vertical field display device and the liquid crystal of the liquid crystal layer 10 being the nematic phase liquid crystal are taken as an example for explanation (the alignment layer is shown in the figure). The pixel electrode 12 and the common electrode 11 are located on each side of the liquid crystal layer 10. Generally, the common electrode 11 may be a planar electrode, and the pixel electrode 12 may be a strip electrode or planar electrode. By adjusting the voltage applied to the pixel electrode 12 and the voltage applied to the common electrode 11, the liquid crystal molecules in the liquid crystal layer 10 may be deflected to adjust the refractive index of the liquid crystal layer 10 is adjusted, thereby adjusting the light output rate of the waveguide layer 302 to realize the adjustment on different gray scales.

In some embodiments, by taking the liquid crystal in the liquid crystal layer 10 being a positive liquid crystal as an example, the refractive index (may be called as initial refractive index) when the liquid crystal layer 10 is not applied with the electrical field (for example, no voltage is applied to the pixel electrode 12 and the common electrode 11) is n0. When the voltage is applied to the pixel electrode 12 and the common electrode 11, a vertical electrical field (the direction of which is vertical to the surface of the first base substrate) is generated between the pixel electrode 12 and the common electrode 11. Under the drive of the vertical electrical field, the refractive index of the liquid crystal layer 10 increases to n′ from n0. When the refractive index of the liquid crystal layer 10 is n0, it is ensured that the incident angle θ of the incident light rays from the side surface of the waveguide layer 302 is larger than a critical angle arcsin (n0/n1) of total reflection, wherein n1 is the refractive index of the waveguide layer 302. Here, the light rays are totally reflected in the waveguide layer 302, and no light rays are output from the waveguide layer 302 and enter the liquid crystal layer 10. Here, the gray scale of the liquid crystal display panel is minimal, and the liquid crystal display panel is in the L0 state. When the refractive index of the liquid crystal layer 10 is n′, the difference between the refractive index of the liquid crystal layer 10 and the refractive index of the waveguide layer 302 is maximal, and the total reflection of the light rays in the waveguide layer 302 is damaged to the greatest extent. Here, the light output rate of the light rays from the waveguide layer 302 is maximal, the gray scale of the liquid crystal display panel is maximal, and the liquid crystal display panel is in the L255 state. When the refractive index of the liquid crystal layer 30 is between the above two cases, the liquid crystal display panel is in other gray scale states.

In addition, in the implementing manner I, under the drive of the vertical electrical field between the pixel electrode 12 and the common electrode 11, the liquid crystal molecules are deflected in a paper surface shown in FIG. 8. Here, only polarized light (e light) of which the vibration direction is within the paper surface can feel the change of the refractive index, while polarized light (o light) of which the vibration direction is vertical to the paper surface cannot feel the change of the refractive index. In such a case, normal display may be realized without the need to dispose a polarizer for the liquid crystal display panel. In addition, as no polarizer is needed to be disposed, the transmittance of the liquid crystal display panel is higher, and therefore it is favorable for the application in the field of transparent display.

Implementing Manner II

As shown in FIG. 2b, the liquid crystal display panel in embodiment of the present disclosure being applied to the ADS-like horizontal field display device and the liquid crystal in the liquid crystal layer being the nematic phase liquid crystal (the alignment layer is not shown in the figure) are taken as an example for explanation. The pixel electrode 12 and the common electrode 11 are located on the same side of the liquid crystal layer 10 and the pixel electrode 12 is more adjacent to the liquid crystal layer 10 than the common electrode 11 is. Generally, the pixel electrode 12 and the common electrode 11 may be strip electrodes. By adjusting the voltage applied to the pixel electrode 12 and the voltage applied to the common electrode 11, the liquid crystal molecules in the liquid crystal layer 10 may be deflected. The refractive index of the liquid crystal layer 10 is adjusted, and thereby the light output rate of the waveguide layer 302 is adjusted to realize the adjustment on different gray scales.

In implementing manner II, under the drive of the horizontal electrical field (of which the direction is parallel with the surface of the first base substrate) between the pixel electrode 12 and the common electrode 11, the liquid crystal molecules in the liquid crystal layer 10 are deflected in a direction vertical to the paper surface shown in FIG. 2b. In such a case, the light rays output from the waveguide layer 302 that have polarization directions along both the e light direction (the light rays of which the vibration direction is within the paper surface) and the o light direction (the light rays of which the vibration direction is vertical to the paper surface) may feel the change of the refractive index. In such a case, in order to ensure the accurate adjustment on the gray scale by the liquid crystal display panel and a better dark state of the liquid crystal display panel, the polarized light (e light or o light) in one polarization direction needs to be filtered out. For example, the e light may be filtered out, and the adjustment on the gray scale is realized by the change of the refractive index of the liquid crystal to the o light during the rotating process. Of course, the o light may be filtered out, and the adjustment on the gray scale is realized by the change of the refractive index of the liquid crystal to the e light during the rotating process, which is not limited in the embodiment of the present disclosure.

In some embodiments, by taking the e light being filtered out as an example, the refractive index of the liquid crystal layer 10 is n0 when no electrical field is applied (for example, no voltage is applied to the pixel electrode 12 and the common electrode 11). When the voltage is applied to the pixel electrode 12 and the common electrode 11, a horizontal electrical field (a direction of which is parallel with the surface of the first base substrate) is generated between the pixel electrode 12 and the common electrode 11. Under the drive of the horizontal electrical field, the refractive index of the liquid crystal layer 10 increases to ne from n0. When the refractive index of the liquid crystal layer 30 to the incident polarized light is n0, light rays are totally reflected in the waveguide layer 302 and no light rays are output from the waveguide layer 302 and enter the liquid crystal layer 10. Here, the gray scale of the liquid crystal display panel is minimal, and the liquid crystal display panel is in the L0 state. Under the drive of the horizontal electrical field between the pixel electrode 12 and the common electrode 11, the liquid crystal molecules deflect, and the refractive index of the liquid crystal layer 10 to the incident polarized light is ne. When the difference between the refractive index of the liquid crystal layer 10 and the refractive index of the waveguide layer 302 is maximal, the total reflection of the light rays in the waveguide layer 302 is damaged to the greatest extent. Here, the light output rate of the light rays from the waveguide layer 302 is maximal, the gray scale of the liquid crystal display panel is maximal, and the liquid crystal display panel is in the L255 state. When the refractive index of the liquid crystal layer 10 is between the above two cases, the liquid crystal display panel is in other gray scale states.

It should be noted that the polarized light (e light or o light) in one polarization direction may be filtered by disposing a polarizer on the light incident side or the light emergent side of the liquid crystal layer 10. The polarized light is filtered out by the polarizer. For example, as shown in FIG. 2b, a polarizer 70 may be disposed between the waveguide layer 302 and the second base substrate 301. That is, the polarizer 70 is disposed on the light emergent side of the liquid crystal layer 10. In addition, when the liquid crystal display panel is applied to the liquid crystal display device, the polarizer may be also disposed in a light emergent position of the light source 40 on the side surface of the waveguide layer 302, such that the light rays emitted from the light source 40 are polarized light. In implementing manner II, the polarizer may filter out one type of polarizer light to realize normal display. For example, a transmitting axis direction of the polarizer 70 may be vertical to the paper surface shown in FIG. 2b. Here, the polarizer 70 may filter out the e light to realize normal display.

Of course, when the liquid crystal display panel in the embodiment of the present disclosure is applied to the ADS-like type horizontal field display devices, the liquid crystal in the liquid crystal layer 10 may also be blue phase liquid crystal. In such a case, the alignment film may not be disposed. When the liquid crystal layer 10 is not applied with an electrical field, the liquid crystal molecules in the liquid crystal layer 10 are in an isotropic state and the refractive index of the liquid crystal layer 10 does not vary in various directions. The refractive indexes of the liquid crystal layer 10 to the two kinds of polarized light are also the same when the polarized light is transmitted through the liquid crystal layer 10, both being N. When the liquid crystal layer 10 is applied with an electrical field, the liquid crystal molecules in the liquid crystal layer 10 are in an anisotropic state. The refractive index to the o light is N1, the refractive index to the e light is N2, and N1<N<N2. In such a case, the isotropic state may be set as the L0 state, and the anisotropic state may be set as the L255 state. Here, the two kinds of polarized light may be coupled from the waveguide layer 302. The waveguide layer 302 has higher light output efficiency. The incident light of display device does not need to be the polarized light.

The present disclosure further provides a light source and a liquid crystal display device with any of the abovementioned liquid crystal display panels. The light source is at a side of the liquid crystal display panel where the light waveguide substrate is.

In some embodiments, the light waveguide substrate may include a second base substrate and a waveguide layer on the second base substrate. The light source is arranged at the side of the second base substrate and/or waveguide layer. The light source may include a collimation light source made of a semiconductor laser chip, a collimation light source made of a light emitting diode or a collimation light source made of a cold cathode fluorescence lamp.

In some embodiments, the liquid crystal display device may be a mobile phone, a tablet computer, a television, a display, a laptop computer, a digital photo frame, a navigator or any other product or part with a display function.

The liquid crystal display device in the embodiment of the present disclosure comprises the above liquid crystal display panel. In the foregoing embodiments, the liquid crystal display panel is introduced by taking an example in which the liquid crystal display panel is applied to a liquid crystal display device. Therefore, the structure of the liquid crystal display device may be made reference to the foregoing embodiments of the liquid crystal display panel. The liquid crystal display device has the same beneficial effects as the liquid crystal display panel provided in the foregoing embodiments. The foregoing embodiments have described the beneficial effects of the liquid crystal display panel in detail, which are not repeated here.

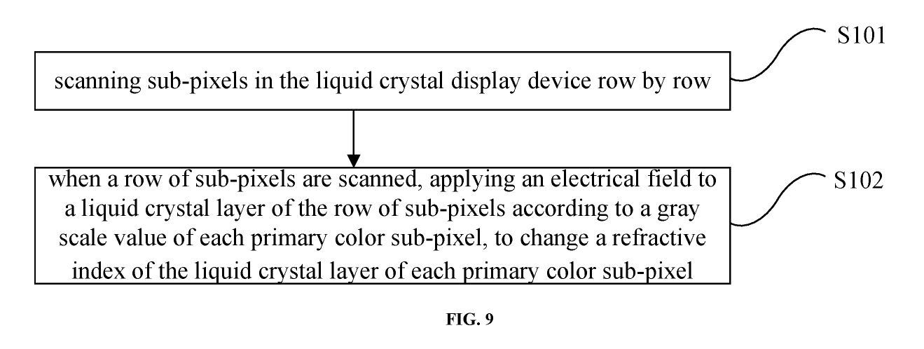

The present disclosure further provides a display method applied to the foregoing liquid crystal display device. As shown in FIG. 9, the method comprises:

Step S101: scanning sub-pixels in the liquid crystal display device row by row.

Step 102: when a row of sub-pixels is scanned, applying an electrical field to a liquid crystal layer of the row of sub-pixels according to a gray scale value of each primary color sub-pixel, to change a refractive index of the liquid crystal layer of each primary color sub-pixel.

In some embodiments, the liquid crystal display device comprises a liquid crystal display panel, a plurality of gate lines and a plurality of data lines. The liquid crystal display panel comprises a plurality of primary color sub-pixels in an array arrangement. The sub-pixels in the liquid crystal display device are the sub-pixels of the liquid crystal display panel. The plurality of primary color sub-pixels in an array arrangement form a plurality of rows of sub-pixels and a plurality of columns of sub-pixels. The plurality of gate lines are in a one-to-one correspondence to the plurality of rows of sub-pixels. The plurality of data lines are in a one-to-one correspondence to the plurality of columns of sub-pixels. Each gate line is connected to each primary color sub-pixel in the row of sub-pixels corresponding to the gate line. Each data line is connected to each primary color sub-pixel in the column of sub-pixels corresponding to the data line. When the sub-pixels in the liquid crystal display device are scanned row by row, the gate lines corresponding to the rows of sub-pixels may be applied with a driving electric signal in sequence, so as to turn on each row of sub-pixels. According to the gray scale value of each sub-pixel in each row of sub-pixels, the data line connected to each primary color sub-pixel in the each row of sub-pixels is applied with a data electric signal, such that the refractive index of the liquid crystal layer of each primary color sub-pixel in the each row of sub-pixels is changed. Wherein, the detailed implementing process for scanning the sub-pixels in the liquid crystal display device row by row may be made reference to the related art, and is not repeated in the embodiments of the present disclosure.

The display method provided in the embodiment of the present disclosure may be applied to the above liquid crystal display device. The liquid crystal display device may comprise the foregoing liquid crystal display panel, and has the same beneficial effects as the liquid crystal display panel provided in the foregoing embodiments. The foregoing embodiments have described the beneficial effects of the liquid crystal display panel in detail, which are not repeated here.

The term “and/or” herein describes the correspondence of the corresponding objects, indicating three kinds of relationship. For example, A and/or B, can be expressed as: A exists alone, A and B exist concurrently, B exists alone. The character “/” generally indicates that the context object is an “OR” relationship.

The foregoing are merely alternative embodiments of the present disclosure and the scope of protection of the present disclosure is not limited hereto. Within the technical scope of the present disclosure, any modifications or substitutions that may readily derived by a person of ordinary skill in the art shall fall in to the scope of protection of the present disclosure. The scope of protection of the present disclosure may be limited only by the claims.

1. A liquid crystal display panel, comprising:
a first base substrate and a light waveguide substrate disposed oppositely;
a liquid crystal layer located between the first base substrate and the light waveguide substrate, and a pixel electrode and a common electrode which are located between the first base substrate and the light waveguide substrate and are configured to drive the liquid crystal layer;
wherein the pixel electrode and the common electrode are configured to drive a refractive index of the liquid crystal layer to be changed, and thereby a light output rate of the light waveguide substrate is changed according to a change of the refractive index of the liquid crystal layer.

2. The liquid crystal display panel according to claim 1, wherein
the liquid crystal display panel further comprises a reflective layer located between the liquid crystal layer and the first base substrate, and the reflective layer is configured to reflect light rays transmitted through the liquid crystal layer and incident to the reflective layer.

3. The liquid crystal display panel according to claim 1, wherein a minimal reflective index of the liquid crystal layer is the refractive index when the liquid crystal layer is not driven by the pixel electrode and the common electrode, and when the refractive index of the liquid crystal layer is the minimal refractive index, incident light rays incident to the light waveguide substrate from a side surface of the light waveguide substrate are totally reflected in the light waveguide substrate.

4. The liquid crystal display panel according to claim 1, wherein
the light waveguide substrate is an integral substrate;
or the light waveguide substrate comprises a second base substrate and a waveguide layer disposed on the second base substrate, and the waveguide layer is adjacent to the liquid crystal layer relative to the second base substrate.

5. The liquid crystal display panel according to claim 1, wherein the light waveguide substrate is a transparent light guide glass plate made of silicon nitride.

6. The liquid crystal display panel according to claim 1, wherein the liquid crystal display panel further comprises: a color filter layer located on one side of the liquid crystal layer away from the first base substrate;
the liquid crystal display panel is divided into a plurality of primary color sub-pixels, the color filter layer comprises a first primary color pattern located in first primary color sub-pixels, a second primary color pattern located in second primary color sub-pixels and a third primary color pattern located in third primary color sub-pixels.

7. The liquid crystal display panel according to claim 1, wherein the reflective layer is a reflective grating, the reflective grating comprises grating units in an array arrangement, and the grating units comprise first grating sub-units configured to emit first primary color light rays, second grating sub-units configured to emit second primary color light rays and third grating sub-units configured to emit third primary color light rays.

8. The liquid crystal display panel according to claim 7, wherein the first grating sub-units are configured to emit the first primary color light rays towards a viewing position, the second grating sub-units are configured to emit the second primary color light rays towards a viewing position, and the third grating sub-units are configured to emit the third primary color light rays towards a viewing position.

9. The liquid crystal display panel according to claim 7, wherein the reflective grating is a blazed grating or columnar grating.

10. The liquid crystal display panel according to claim 7, wherein a duty ratio of the reflective grating is approximately 0.5, the value range of a height of the reflective grating is approximately 200 nm-1000 nm, and the value range of a period of the reflective grating is approximately 100 nm-1 μm.

11. The liquid crystal display panel according to claim 1, wherein the liquid crystal layer is in contact with the light waveguide substrate.

12. The liquid crystal display panel according to claim 1, wherein the light output rate of the light waveguide substrate is in a positive correlation with the refractive index of the liquid crystal layer.

13. The liquid crystal display panel according to claim 1, wherein liquid crystal molecules in the liquid crystal layer are nematic phase liquid crystal molecules, blue phase liquid crystal molecules or polymer-stabilized liquid crystal molecules.

14. The liquid crystal display panel according to claim 13, wherein the liquid crystal molecules in the liquid crystal layer are nematic phase liquid crystal molecules, and the liquid crystal display panel further comprises an alignment layer located on each side of the liquid crystal layer and is in contact with the liquid crystal layer.

15. The liquid crystal display panel according to claim 14, wherein the pixel electrode and the common electrode are located on a same side of the liquid crystal layer, and the liquid crystal display panel further comprises a polarizer located on a light incident side or light emergent side of the liquid crystal layer.

16. A liquid crystal display device, comprising a light source and the liquid crystal display panel according to claim 1, wherein the light source is located on a side surface of a light waveguide substrate of the liquid crystal display panel.

17. The liquid crystal display device according to claim 16, wherein the light waveguide substrate comprises a second base substrate and a waveguide layer disposed on the second base substrate, and the light source is located on a side surface of the second base substrate and/or the waveguide layer.

18. The liquid crystal display device according to claim 16, wherein the light source adopts a collimation light source made of a semiconductor laser chip, a collimation light source made of a light emitting diode or a collimation light source made of a cold cathode fluorescence lamp.

19. A display method applied to the liquid crystal display device according to claim 16, comprising:
scanning sub-pixels in the liquid crystal display device row by row; and
when a row of sub-pixels are scanned, applying an electrical field to a liquid crystal layer of the row of sub-pixels according to a gray scale value of each primary color sub-pixel, to change a refractive index of the liquid crystal layer of each primary color sub-pixel.
